(19) United States
(12) Patent Application Publication
(10) Pub. No.: US 2004/0203956 A1
(43) Pub. Date: Oct. 14, 2004

(54) Method and apparatus for providing wireless messaging

(76) Inventor: Ioannis Tsampalis, Chicago, IL (US)

Correspondence Address: VEDDER PRICE KAUFMAN & KAMMHOLZ, 222 N. LASALLE STREET, CHICAGO, IL, 60601, US

(21) Appl. No.: 10/335,140

(22) Filed: Dec. 31, 2002

(51) Int. Cl. H04Q 7/20

(52) U.S. Cl. 455/466; 455/412.1

(57) ABSTRACT

A first mobile wireless communication device (100) includes mobile wireless communication device messaging format capabilities determinator circuitry (104) operable to obtain second mobile wireless communication device messaging format capabilities information (110) of a second mobile wireless communication device (100) and send message circuitry, operable to send a message (112) in a message format compatible with at least one of the formats identified in the second mobile wireless communication device messaging format capabilities information (110).

### FIELD OF THE INVENTION

The invention relates generally to wireless communication systems and methods, and more particularly to methods and apparatus for providing wireless messaging.

### BACKGROUND OF THE INVENTION

Mobile messaging systems, characterized by their non-real-time store-and-forward messaging to and from mobile messaging devices, currently exist. For example, Short Messaging Service (SMS), a text based mobile message system, is such a messaging service. Further, both Enhanced Messaging Service (EMS) and Multi-Media Service (MMS), each text-plus based mobile messaging systems, are also mobile messaging systems.

Current networks are known to exist which support the concurrent operation of multiple mobile messaging systems. In addition, such networks are also known to include mobile messaging devices that are compatible with only a subset of the supported concurrent multiple mobile messaging systems. Such networks permit the sending of messages from a sending mobile messaging device having a first mobile messaging system format (e.g., MMS) to a receiving mobile messaging device capable of only receiving messages in a second mobile messaging system format (e.g., SMS). Being unable to process the message due to the incompatibility of its messaging service capabilities with that of the format of the received message, the receiving mobile messaging device then typically bounces the message back to the sending mobile messaging device.

In this case where the message is bounced back due to an incompatible message system format, the sending messaging device is typically unable to determine this incompatibility until after the message is sent. More specifically, the sending messaging device is typically only aware of the incompatibility after a number of events occur, namely: the message has been fully completed and the list of delivery recipients has been set for delivery, the sending of the message has completed, the message has reached the receiving device, and the message has been bounced back to the sending device. As such, because the sending device is unaware of the incompatibility until after the message is bounced back, there is no opportunity for the sending device to change the content of the message, change the recipient list associated with the message, or choose not to send the message, before sending a message that will later be bounced back.

### BRIEF DESCRIPTION OF THE DRAWINGS

The invention will be more readily understood with reference to the following drawings wherein like reference numerals represent like elements and wherein:

FIG. 1 is a block diagram illustrating one example of a system in accordance with one embodiment of the invention that provides the obtaining of mobile wireless communication device messaging format capabilities before sending a message to the mobile wireless communication device.

FIG. 2 is a detailed block diagram illustrating one example of a system in accordance with one embodiment of the invention that provides the obtaining of mobile wireless communication device messaging format capabilities before sending a message to the mobile wireless communication device in accordance with one embodiment to the invention;

FIG. 3 is a block diagram illustrating the use of a phonebook as used in one example of a system in accordance with one embodiment of the invention;

FIG. 4 is a block diagram illustrating the use of an active message recipient list as used in one example of a system in accordance with one embodiment of the invention;

FIG. 5 is a method for obtaining of mobile wireless communication device messaging format capabilities before sending a message to the mobile wireless communication device in accordance with one embodiment of the invention;

FIG. 6 is a method, containing further detail associated with, obtaining of mobile wireless communication device messaging format capabilities before sending a message to the mobile wireless communication device in accordance with one embodiment of the invention;

FIG. 7 is a method, containing further detail associated with, obtaining of mobile wireless communication device messaging format capabilities before sending a message to the mobile wireless communication device in accordance with one embodiment of the invention;

FIG. 8 is a method, containing further detail associated with, obtaining of mobile wireless communication device messaging format capabilities before sending a message to the mobile wireless communication device in accordance with one embodiment of the invention.

FIG. 9 is a method, containing further detail associated with, obtaining of mobile wireless communication device messaging format capabilities before sending a message to the mobile wireless communication device in accordance with one embodiment of the invention;

FIG. 10 is a flow chart illustrating one example of a method for obtaining of mobile wireless communication device messaging format capabilities before sending a message to the mobile wireless communication device in accordance with one embodiment of the invention;

FIG. 11 is a flow chart illustrating one example of a method for obtaining of mobile wireless communication device messaging format capabilities before sending a message to the mobile wireless communication device in accordance with one embodiment of the invention;

FIG. 12 is a flow chart illustrating one example of a method for obtaining of mobile wireless communication device messaging format capabilities before sending a message to the mobile wireless communication device in accordance with one embodiment of the invention;

FIG. 13 is a flow chart illustrating one example of a method for obtaining of mobile wireless communication device messaging format capabilities within an MMS based system, before sending a message to the mobile wireless communication device in accordance with one embodiment of the invention;

FIG. 14 is a more detailed representation of some of the aspects associated with the method of FIG. 13;

FIG. 15 is a more detailed representation of some of the aspects associated with the method of FIG. 13; and

FIG. 16 is a more detailed representation of some of the aspects associated with the method of FIG. 13.

### DETAILED DESCRIPTION OF THE PREFERRED EMBODIMENT

Briefly, a method and apparatus, obtains mobile wireless communication device messaging format capabilities information, such as non-real-time store-and-forward messaging format capabilities, of a receiving mobile wireless communication device. The method and apparatus, sends a message to the receiving mobile wireless communication device in a message format compatible with one of the formats identified with the messaging format capabilities of the second mobile wireless communication device. Hence, different mobile wireless communication devices (e.g., cell phones, two-way pagers and other devices suitable for using non-real-time store-and-forward messaging) send and receive messages formatted under different types of non-real-time store-and-forward messaging that are understood by a receiving device. In one embodiment, such devices are also capable of obtaining messaging format capabilities information from a target or recipient mobile wireless communication device, that reflect which types of non-real-time store-and-forward messaging formats a mobile wireless communication device is capable of processing. Such devices, using the messaging format capabilities information, then send a message to a target mobile wireless communication device in a format that can be processed by the target mobile wireless communication device.

In one embodiment, a sending mobile wireless communication device stores the obtained messaging format capabilities information of the receiving mobile wireless communication device in a phonebook accessible by the sending mobile wireless communication device. This provides for the advantage of quickly and locally obtaining the messaging format capabilities information of the receiving mobile wireless communication device without having to retrieve such information externally over a network. Further, of those embodiments utilizing a phonebook, such phonebook may be located separate from the sending mobile wireless communication device including at a location on the network.

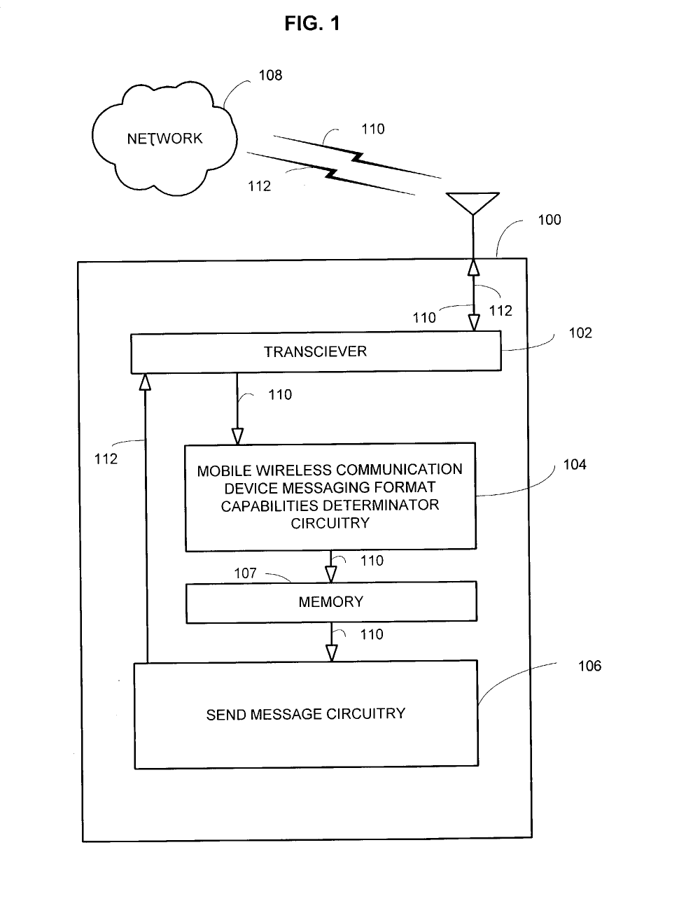

FIG. 1 illustrates a mobile wireless communication device such as a cellular telephone, two-way pager, or other device employing non-real-time store-and-forward messaging (e.g., SMS, EMS, MMS messaging). As shown, a first mobile wireless communication device 100 contains a transceiver 102, mobile wireless communication device messaging format capabilities determinator circuitry 104, send messaging circuitry 106 and memory 107. Although shown separated here, other embodiments may combine the circuitry of the mobile wireless communication device messaging format capabilities determinator circuitry 104 and the send messaging circuitry 106. Further, the first mobile wireless communication device 100 is further connected to network 108. As used in this document, the term circuitry includes at least the following: one or more processing devices executing software stored in memory, such as microprocessors, digital signal processors (DSPs), microcontrollers or alternatively discrete logic, state machines, or any suitable combination of hardware, software stored in memory and/or firmware. Further, in a preferred embodiment, the mobile wireless communication device messaging format capabilities determinator circuitry 104 and the send messaging circuitry 106 are software modules executing on DSPs contained within a mobile wireless communication device. Further, memory, as used herein, may be RAM, ROM, distributed memory in one or more circuits or locations, optical or magnetic memory, or any suitable memory that is capable of storing digital information.

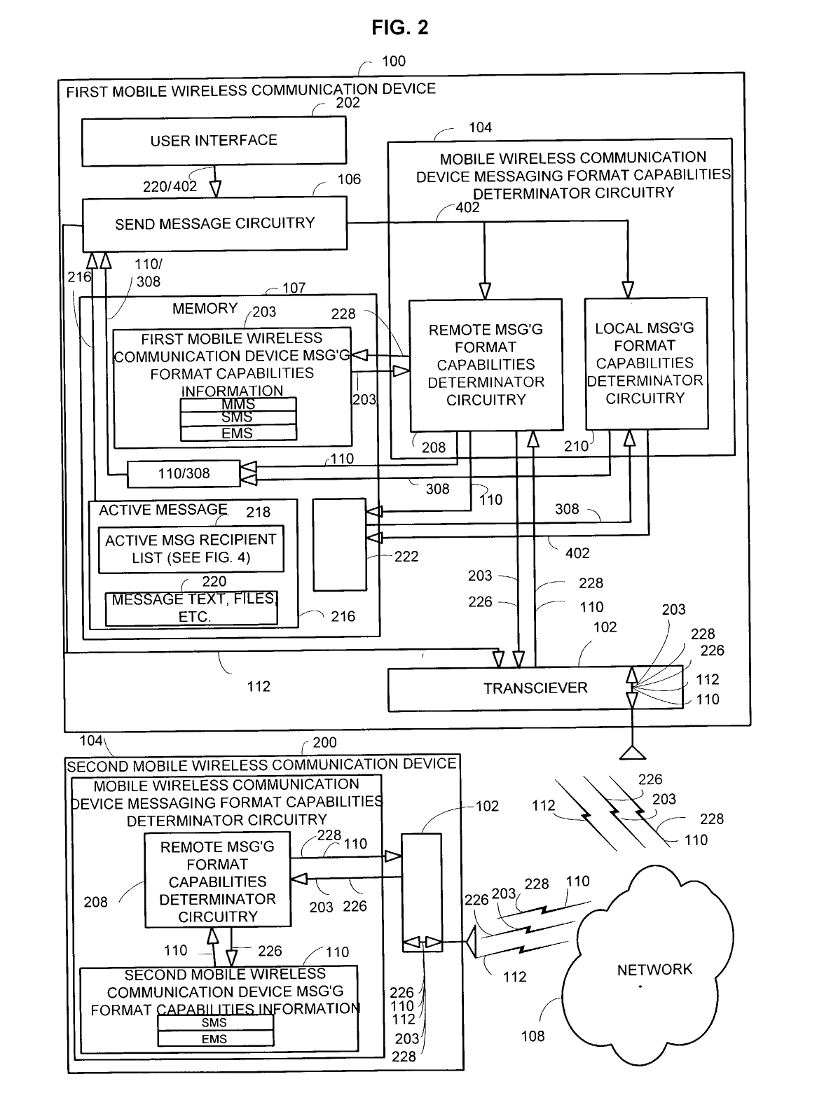

In operation, the mobile wireless communication device messaging format capabilities determinator circuitry 104 communicates through the transceiver 102 to the network 108 to obtain second mobile wireless communication device messaging format capabilities information 110. The second mobile wireless communication device messaging format capabilities information 110 may be data representing that the device can process messages that are in an SMS format, EMS format, or another suitable format. The second mobile wireless communication device messaging format capabilities information 110 may be received from a target device, network element, or any other suitable source. The second mobile wireless communication device messaging format capabilities information 110 is received back from the network 108 through the transceiver 102 to the mobile wireless communication device messaging format capabilities determinator circuitry 104. The second mobile wireless communication device messaging format capabilities information 110 is stored in memory 107 and is associated with the corresponding second mobile wireless communication device (see FIG. 2). The send message circuitry 106 operates to send a message in a message format compatible with at least one of the formats identified in the second mobile wireless communication device messaging format capabilities information 110. The send message circuitry 106 sends message 112, in a format identified in the second mobile wireless communication device messaging format capabilities information 110, to the network 108 via the transceiver 102.

Further, if desired, first mobile wireless communication device 100 may operate such that the send message circuitry 106 allows a user to choose whether or not to send the message 112 depending on the second mobile wireless communication device messaging format capabilities information 110. For example, if the second mobile wireless communication device messaging format capabilities information 110 does not contain a message format capability possessed by the first mobile wireless communication device 100, then, the user may choose to not send the message to a second mobile wireless communication device 200 as the message would be expected to be bounced back since it is now known to be incompatible with message format capabilities of the first mobile wireless communication device.

The circuitry described above, including the mobile wireless communication device messaging format capabilities determinator circuitry 104 and the send message circuitry 106, is preferably software modules. Such software modules can be stored as computer code on a variety of computer readable mediums, such as floppy disks, hard disks, compact disks, optical storage media, or any other suitable storage means for digital information. And such computer readable program code stored on such mediums, can be executed, causing one or more processors to perform the functionality inherent in such code, and as described above.

FIG. 2 illustrates a system containing a first and second mobile wireless communication devices, 100 and 200, connected over a wireless network such as a cellular wireless network, internet or other suitable network. Components similar to those shown in FIG. 1 are also included in the second mobile wireless communication device 200, and include the transceiver 102 and the mobile wireless communication device messaging format capabilities determinator circuitry 104.

In addition, other components for the first mobile wireless communication device 100 not previously introduced in FIG. 1 are also shown in FIG. 2. Such components include user interface 202, the first mobile wireless communication device messaging format capabilities information 203, remote messaging format capabilities determinator circuitry 208, local messaging format capabilities determinator circuitry 210, active message 216, active message recipient list 218, message text, files, etc. 220, and phonebook 222. Further, in one embodiment both phonebook 222 and active message recipient list 218 are both databases and both are stored in memory 107.

Further, FIG. 2 shows the second mobile wireless communication device 200 to include the following: transceiver 102, mobile wireless communication device messaging format capabilities determinator circuitry 104; second mobile wireless communication device messaging format capabilities information 110 and remote messaging format capabilities determinator circuitry 208.

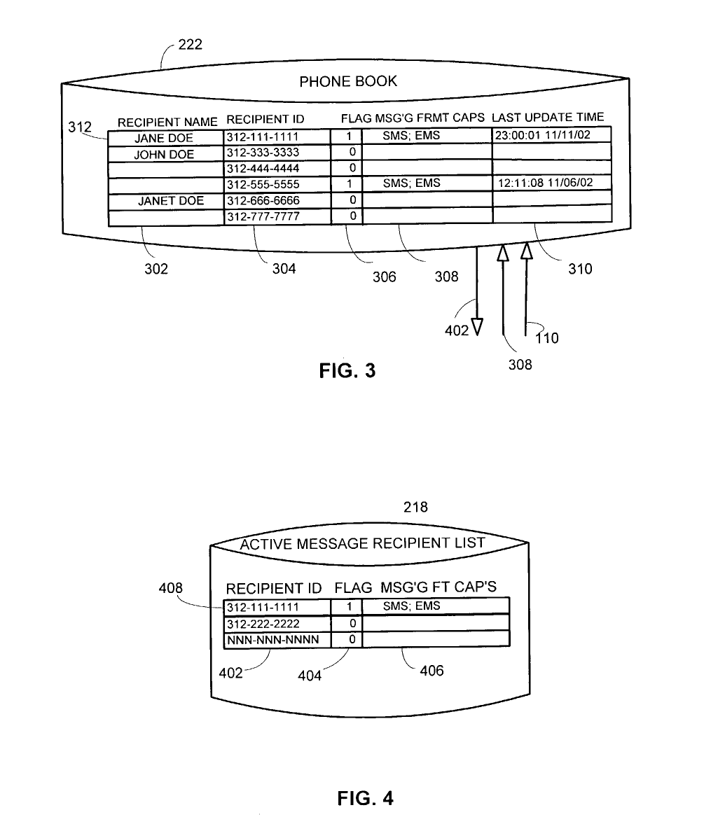

FIG. 3 shows, in greater detail, the phonebook 222. Specifically, the phonebook 222 is shown to include recipient name 302, recipient ID 304, phonebook flag 306, phonebook messaging format capabilities 308, phonebook last update time 310, and individual phonebook entry 312.

FIG. 4 shows, in greater detail, the active message recipient list 218 of first mobile wireless communication device 100. Specifically, active message recipient list 218 is further shown to include a recipient ID 402, recipient list recipient list flag 404 and a recipient list messaging format capabilities 406 as well as individual recipient list entry 408.

In operation, and referencing FIGS. 2-4, a user (not shown) interacts with the first mobile wireless communication device 100 via the user interface 202 by entering message text, files, etc. 220 and an active message recipient list 218. As the active message recipient list 218 is populated with each recipient ID 402, then, in one embodiment having local messaging format capabilities determinator circuitry 210 and a phonebook 222, immediately after each such recipient ID 402 is entered, the send message circuitry 106 interacts the mobile wireless communication device messaging format capabilities determinator circuitry 104, specifically the local messaging format capabilities determinator circuitry 210, to retrieve the second mobile wireless communication device messaging format capabilities information 110 associated with the second mobile wireless communication device 200. If such recipient 402 is found in the phonebook 222, then, for that individual phonebook entry 312, it is determined whether there is a corresponding phonebook flag 306 set for that recipient ID 402. If the phonebook flag 306 is not set, the remote messaging format capabilities determinator circuitry 208 is called to determine the second mobile wireless communication device messaging format capabilities information 110. However, if the phonebook flag 306 is set for the individual phonebook entry 312, the phonebook messaging format capabilities 308, (e.g., the second mobile wireless communication device messaging format capabilities information 110 previously stored in the phonebook), are returned to the local messaging format capabilities determinatory circuitry 210. The phonebook messaging format capabilities 308 are subsequently associated with the corresponding individual recipient list entry 408 in the active message recipient list 218 as the new recipient list messaging format capabilities 406. Note, that the storing of the second mobile wireless communication device messaging format capabilities information 110 in an associated phonebook with the first mobile wireless communication device 100 provides quicker access to the capabilities information of the second mobile wireless communication device 200 than if such information is only available over the network. Further, other embodiments do not utilize a phonebook 222 to store second mobile wireless communication device messaging format capabilities information 110, and as such retrieve the information remotely when needed.

Further, if the corresponding phonebook flag 306 is set, (e.g., limited messaging capabilities have already been identified as being associated with such second mobile wireless communication device 200), and the phonebook's last update time 310 has expired, (the time to refresh such messaging capabilities information has arrived), or if the phonebook flag 306 is not set, (e.g., no limited messaging capabilities have yet been identified as being associated with such second mobile wireless communication device 200), then the remote message format capabilities determinator circuitry 208 is then invoked and generates a second mobile wireless communication device messaging format capabilities information request 226 which is sent to the second mobile wireless communication device 200. Further, in the case where a local phonebook 222 and local messaging format capabilities determinator circuitry 210 is not used, (e.g., where the second mobile wireless communication device messaging format capabilities information 110 must be retrieved remotely), then for each recipient 402 entered in the active message recipient list 218, the same remote message format capabilities determinator circuitry 208 is then invoked to generate a second mobile wireless communication device messaging format capabilities information request 226.

After the first mobile wireless communication device 100 sends the second mobile wireless communication device messaging format capabilities information request 226, the second mobile wireless communication device 200's remote messaging format capabilities determinator circuitry 208 receives the second mobile wireless communication device messaging format capabilities information request 226. The second mobile wireless communication device 200 retrieves and sends the second mobile wireless communication device messaging format capabilities information 110 to the first mobile wireless communication device 100 in response to the information request 226 containing the second mobile wireless communication device messaging format capabilities information 110. The remote messaging format capabilities determinator circuitry 208 in the first mobile wireless communication device 100 receives the second mobile wireless communication device messaging format capabilities information 110 and stores this information in memory 107 in a manner that associates the second mobile wireless communication device messaging format capabilities information 110 with the corresponding second mobile wireless communication device 200 stored as a recipient in active message recipient list 218. If an attached phonebook 222 exists (e.g., the associated embodiment includes the use of such a phonebook for storing such information) and either the corresponding individual phonebook entry 312 does not have a flag set, or the flag is set and the phonebook last update time 310 has expired, then, in either case, the second mobile wireless communication device messaging format capabilities information 110 will then be stored in the phonebook's 222 phonebook messaging format capabilities 308 for the corresponding individual phonebook entry 312. This process of utilizing the mobile wireless communication device messaging format capabilities determinator circuitry 104 to determine the message format capabilities of the corresponding recipient ID 402, is repeated for each recipient ID 402 entered in active message recipient list 218. Although each such recipient ID 402 is checked as it is entered in the preferred embodiment, other embodiments include waiting to check such recipient ID 402 until after multiple recipient IDs are entered.

When the user interface 202 detects a request to send the active message 216 (unformatted), the user interface 202 communicates this information to the send message circuitry 106. Upon detection of a request to send the message 112, a process begins which includes the looping through of the recipient IDs 402 in the active message recipient list 218 to send messages to each designated recipient. The send message circuitry 106, for each recipient ID 402 with a recipient list flag 404 not set, sends the message 112 in the default format of the first mobile wireless communication device 100 to the corresponding mobile wireless communication devices associated with the particular recipient IDs 402.

Further, for those recipient IDs 402 that have a corresponding recipient list flag 404 set, the send message circuitry 106 sends, to the user interface 202, a prompt to the user (not shown). The prompt presents to the user a question as to whether the user would like the active message 216 formatted in a format identified in the recipient list messaging format capabilities 406 or whether the user would like the active message 216 sent to the recipient ID 402 in the default messaging capability of the first mobile wireless communication device 100. If the user chooses to send the active message 216 in a format of the recipient list messaging format capabilities 406, the active message 216 is formatted in the selected messaging format capability, (e.g., message 112), and is sent to the second mobile wireless communication device 200. If, on the other hand, the user chooses to send the active message 216 in the default message capability of the first mobile wireless communication device 100, the send message circuitry 106 sends message 112 in such a format. Here, the send message circuitry 106 formats the message prior to sending the message. Where the second mobile wireless communication device 200 is not compatible with the default message capability of the first mobile wireless communication device 100, the second mobile wireless communication device 200 bounces back message 112 to the first mobile wireless communication device 100 indicating that the message could not be read.

Although this embodiment did not specifically prompt the user regarding each of the potential second mobile wireless communication device messaging format capabilities information 110, if desired, the device 100A prompts the user to select which among the second mobile wireless communication device messaging format capabilities information 110 to format the active message 216 in before sending the message 112 to the second mobile wireless communication device 200.

In one alternative embodiment, the second mobile wireless communication device messaging format capabilities information 110 is stored in a location other than within the second mobile wireless communication device 200, for example, such as a network element within the network 108. Such a network device could be a web server or other server that may contain format capabilities for a plurality of devices.

In another alternative embodiment, the phonebook 222, the local messaging format capabilities determinator circuitry 210 is not included. Here, the second mobile wireless communication device messaging format capabilities information 110 is only available from the second mobile wireless communication device 200. Thus, the only way to retrieve this information is utilize the remote messaging format capabilities determinator circuitry 208 to retrieve the second mobile wireless communication device messaging format capabilities information 110 from the second mobile wireless communication device 200.

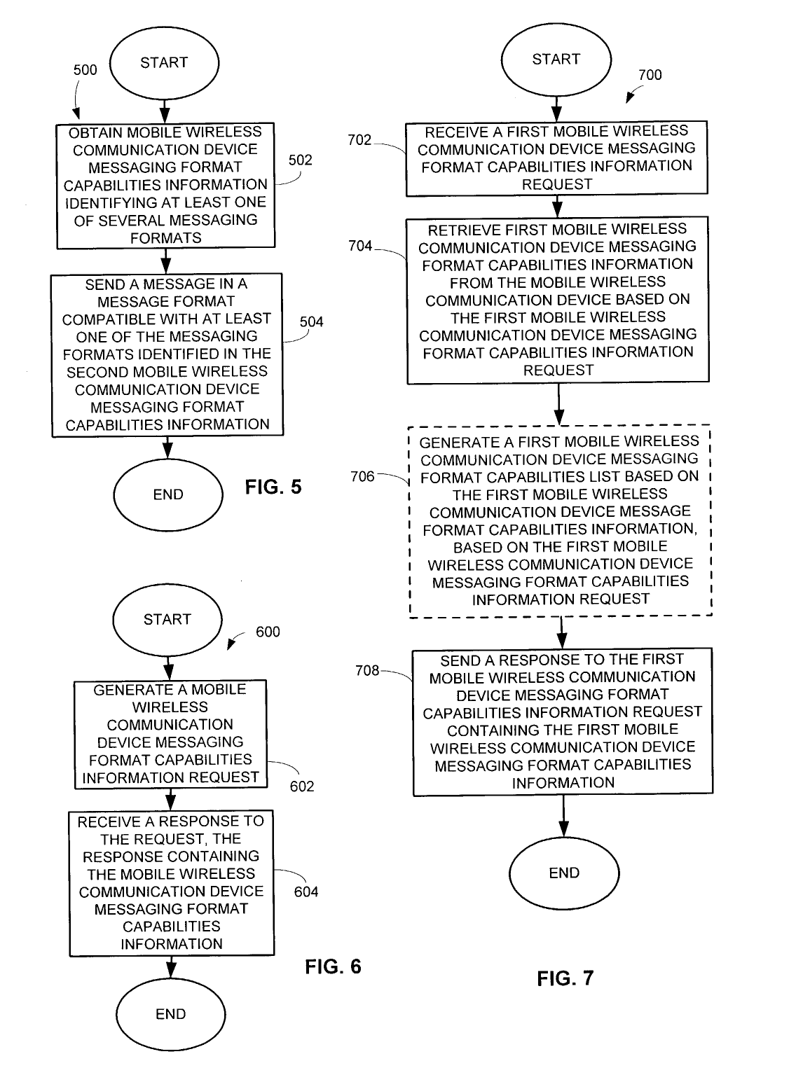

FIG. 5 illustrates a method 500 of messaging a mobile wireless communication device. As shown in block 502, the method includes obtaining mobile wireless communication device messaging format capabilities information identifying at least one of several messaging formats that are used by a receiving device. This may be done using the mobile wireless communication device messaging format capabilities determinator circuitry 104, or other suitable circuitry. Alternatively, this may also be done locally on information stored in a local phonebook 222 where the output generated therefrom includes mobile wireless communication device messaging format capabilities information. Further, step 504 illustrates sending of a message in a message format compatible with at least one of the messaging formats identified in the second mobile wireless communication device messaging format capabilities information. This may be done using the send message circuitry 106 or other suitable circuitry.

FIG. 6 illustrates a method 600 of obtaining mobile wireless communication device messaging format capabilities information. As shown in step 602, the method includes generating a mobile wireless communication device messaging format capabilities information request. This may be done, for example, using the remote messaging format capabilities determinator circuitry 208. However, other suitable circuitry may be used. In addition, the method includes receiving a response to the request where the response contains the second mobile wireless communication device messaging format capabilities information 110, as shown in step 604. This may be accomplished using the remote messaging format capabilities determinator circuitry 208 or other suitable circuitry.

FIG. 7 illustrates a method 700 for providing mobile wireless communication device messaging format capabilities information 203 is described from the perspective of the first mobile wireless communication device 100 providing the first mobile wireless communication device messaging format capabilities information 203 rather than from the second mobile wireless communication device). As shown in step 702, the method includes receiving a first mobile wireless communication device messaging format capabilities information request 228. This can be accomplished using the remote messaging format capabilities determinator circuitry 208, or any suitable circuitry. Step 704 is also included to illustrate the retrieval of the first mobile wireless communication device messaging format capabilities information 203 from the first mobile wireless communication device 100 based on the first mobile wireless communication device messaging format capabilities information request 228. The retrieval of such information can be achieved using the remote messaging format capabilities determinator circuitry 208 or other suitable circuitry. Finally, as shown in step 708, the method includes sending a response to the first mobile wireless communication device messaging format capabilities information request 228 containing the first mobile wireless communication device messaging format capabilities information 203. Further, an optional step 706 may be included, such as generating a first mobile wireless communication device messaging format capabilities list, such as a text based representation of such capabilities, based on the first mobile wireless communication device messaging format capabilities information 203. Here, for example, using known techniques for converting non-text data into text data, the first mobile wireless communication device messaging format capabilities information 203 may used to create a text representation of such information (e.g., “SMS; EMS”).

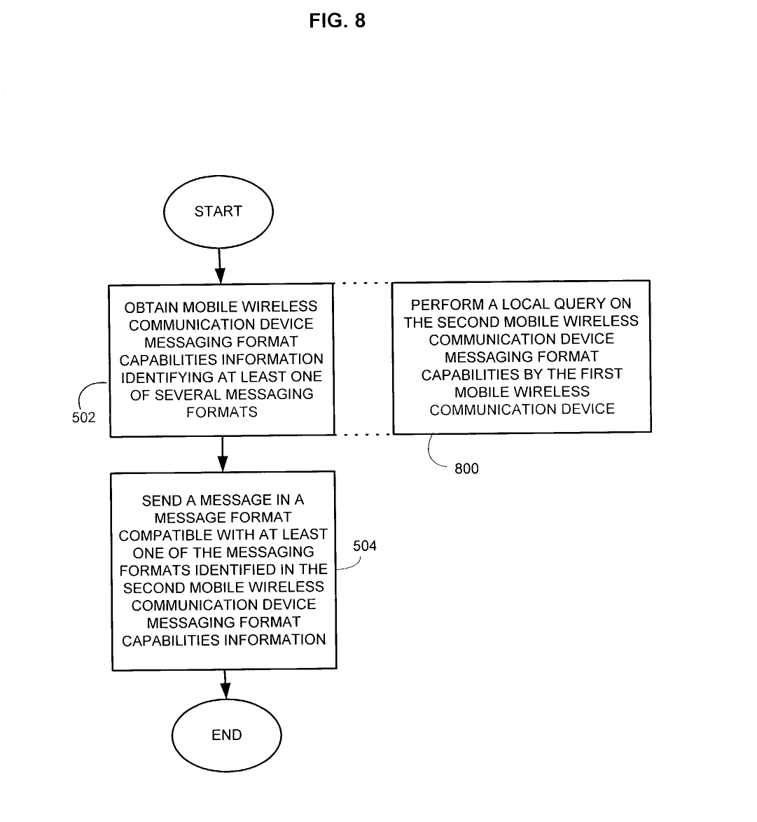

FIG. 8 illustrates a method of obtaining mobile wireless communication device messaging format capabilities. The method includes, as shown in step 800, determining the second mobile wireless communication device messaging format capabilities information 110 locally by the first mobile wireless communication device 100. This can be achieved using the local messaging format capabilities circuitry 210 or any suitable circuitry. Further, the method is directed towards the case where the second mobile wireless communication device messaging format capabilities information 110 has been stored in the phonebook 222 of the first mobile wireless communication device 100 such that the information is available without having to access the second mobile wireless communication device 200. Further, if after the obtaining of such information is performed, and the second mobile wireless communication device 200 is found not to have an entry in the local phonebook 222, then the method 600 and method 700 are then performed to retrieve the second mobile wireless communication device messaging format capabilities information 110 from the remote second mobile wireless communication device 200.

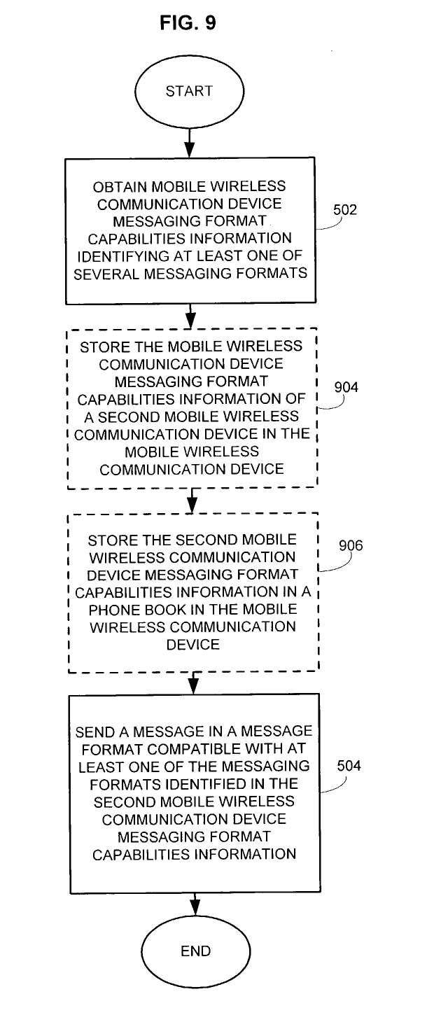

FIG. 9 illustrates two optional steps for use with method 500. As shown in step 904, the method may include storing of second mobile wireless communication device messaging format capabilities information 110 of the second mobile wireless communication device 200 in the first mobile wireless communication device 100. The other optional step, 906, includes the storing of the second wireless communication device messaging format capabilities information 110 in a phonebook 222 in the first mobile wireless communication device 100. Both of these optional steps provide for the local storing of otherwise remote information, and as such, allow for the local and quick access of such information. It is contemplated that this stored information periodically based on a time stamp which expires after a certain period, thus requiring a new access to the remote wireless device to update this information locally. Further, this above described storing functionality can be achieved by using the local messaging format capabilities determinator circuitry 212 if desired.

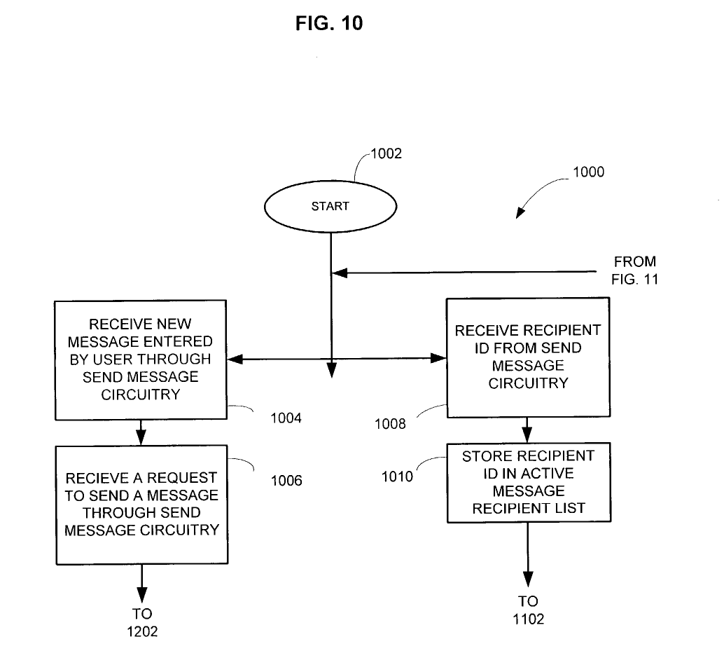

FIGS. 10, 11 and 12 together, represent another example of a method of obtaining mobile wireless communication device messaging format capabilities. The method includes the entry of the active message 216 as well as the populating a portion of the active message recipient list 218. The method is shown to start with block 1002. As shown in Block 1004, the method includes the receiving a new unformatted message 110 entered by a user through the send message circuitry 106. Although the send message circuitry is used here, any other suitable circuitry may be used. As shown in Block 1006, the method includes the receiving a request to send an active message 216 through the same send message circuitry 106. Again, other suitable circuitry may be used. Block 1008 demonstrates the method including the receiving of a next recipient ID 402 as the recipient ID is entered in the send message circuitry 106. Here again, other suitable circuitry may be used. As shown in Block 1010, the method includes the storing of the recipient ID 402 in an active message recipient list 218 using the send message circuitry 106. It should be understood that other circuitry may be used to perform the same function. In this embodiment, the user is allowed perform method as reflected in the steps 1004 and 1008 in any chosen sequence. For example, the user may begin by entering one recipient ID, typing one paragraph of the message, entering a second recipient ID, and entering a second paragraph of the message. Also in this embodiment, the process of message entry and the recipient ID 402 entry is terminated upon the user indicating that they wish to send the message.

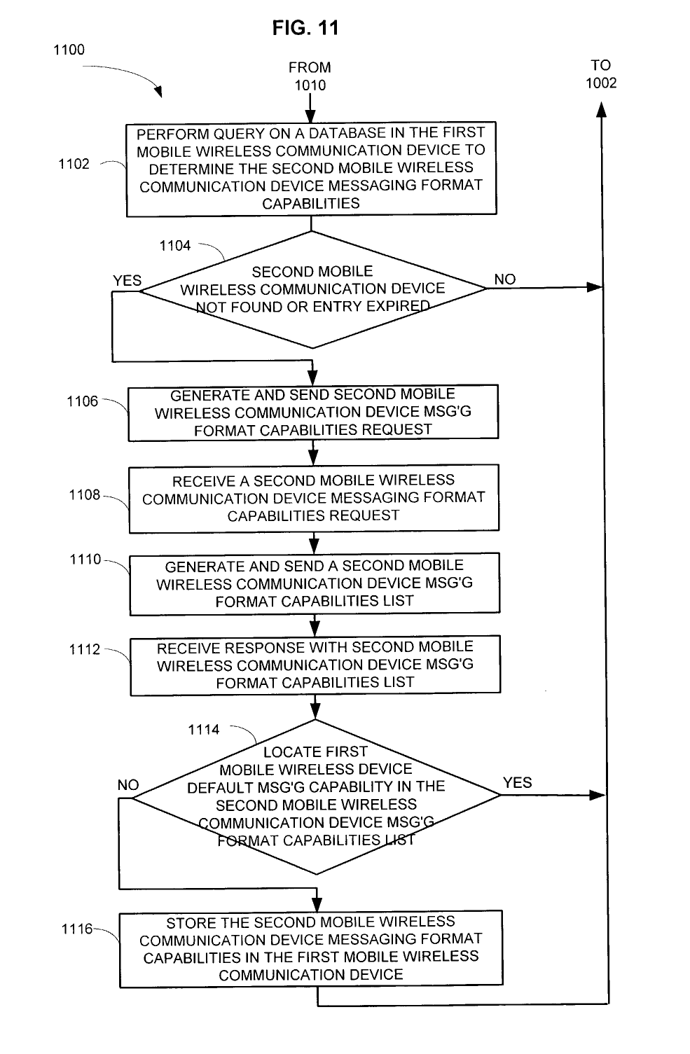

FIG. 11 further illustrates the method reflected in FIGS. 10, 11 and 12, and illustrates the method which includes the retrieval of the second mobile wireless communication device message format capabilities information 110 from either a local or a remote location. More specifically, FIG. 11 includes block 1102 illustrating the method including utilization of a data base (e.g., phonebook 222) in the first mobile wireless communication device 100 to determine the second mobile wireless communication device messaging format capabilities information 110. Here, a local database is examined to see if the messaging capabilities of the second mobile wireless device are stored locally. This functionality is achieved using the local messaging format capabilities determinator circuitry 224A, but may be accomplished using different circuitry. Further, although the database is shown to be connected locally, the database can be located elsewhere such as a remote network location. As shown in Block 1104, the method includes the operation of determining whether the second mobile wireless communication device 200 is not found in the local database (e.g., phonebook 222) or whether the individual entry is found (individual phonebook entry 312) but has expired, (e.g., phonebook last update time 310 has expired, and therefore, the corresponding information should be retrieved from the second mobile wireless communication device). This can be done using the mobile wireless communication device messaging format capabilities determinator circuitry 104, or can be done using other suitable circuitry. When the second mobile wireless communication device 200 is not found in a local database or the associated individual entry is found but is found to have expired, the method, as illustrated in block 1106, generates and sends a second mobile wireless communication device messaging format capabilities request 226 to the second mobile wireless communication device 200. Again, this can be accomplished using the remote messaging format capabilities circuitry 208, or other suitable circuitry. If, in contrast, the second mobile wireless communication device 200 is found in a local database or the associated individual entry is found and has not yet expired, the method returns to the functionality indicated in FIG. 10 block 1002.

As shown in Block 1108, the method includes receiving of a second mobile wireless communication device messaging format capabilities request 226 typically generated by the functionality reflected in block 1106. This is performed using the remote messaging format capabilities determinator circuitry 208, but may be accomplished using other suitable circuitry. As shown in Block 1110, the method includes the sending of a second mobile wireless communication device messaging format capabilities list from the second mobile wireless communication device 110 based on the second mobile wireless communication device messaging format capabilities request 226. This sending functionality is accomplished using the remote messaging format capabilities determinator circuitry 208, however, other suitable circuitry may be used. As shown in Block 1112, the method includes the receiving of the second mobile wireless communication device messaging format capabilities list. This can be accomplished by using the remote messaging format capabilities determinator circuitry 208, or using other suitable circuitry. As illustrated in Block 1114, the use of a locate function for the detection of the presence of a first mobile wireless device default messaging format in the second mobile wireless communication device messaging format capabilities list. This functionality can be achieved using the mobile wireless communication device messaging format capabilities circuitry 104. However, other suitable circuitry may be used.

Where the default messaging format of the first mobile wireless communication device is not found in the second mobile wireless communication device messaging format capabilities list, step 1116 illustrates functionality which stores the second mobile wireless communication device messaging format capabilities list in the first mobile wireless communication device 100. This can be done using the remote messaging format capabilities determinator circuitry 208, however, other suitable circuitry may be used. Here, the storage could be in both, or either, of the active message recipient list 218 and/or the phonebook 222. If, however, the first mobile wireless communication device is found in the second mobile wireless communication device messaging format capabilities list, the method then returns to FIG. 10's block 1002 (e.g., nothing to do as compatibility already exists and the message can simply be sent in the typical default messaging format of the sending device). Further, after performing the storage function as illustrated in block 1116, the method returns to FIG. 10 block 1002. Here, the second mobile wireless communication device messaging format capabilities have been identified and stored in the first mobile wireless device 100 for a current recipient, and the method returns to the message entry process of FIG. 10 ready for the entry of additional recipients entries.

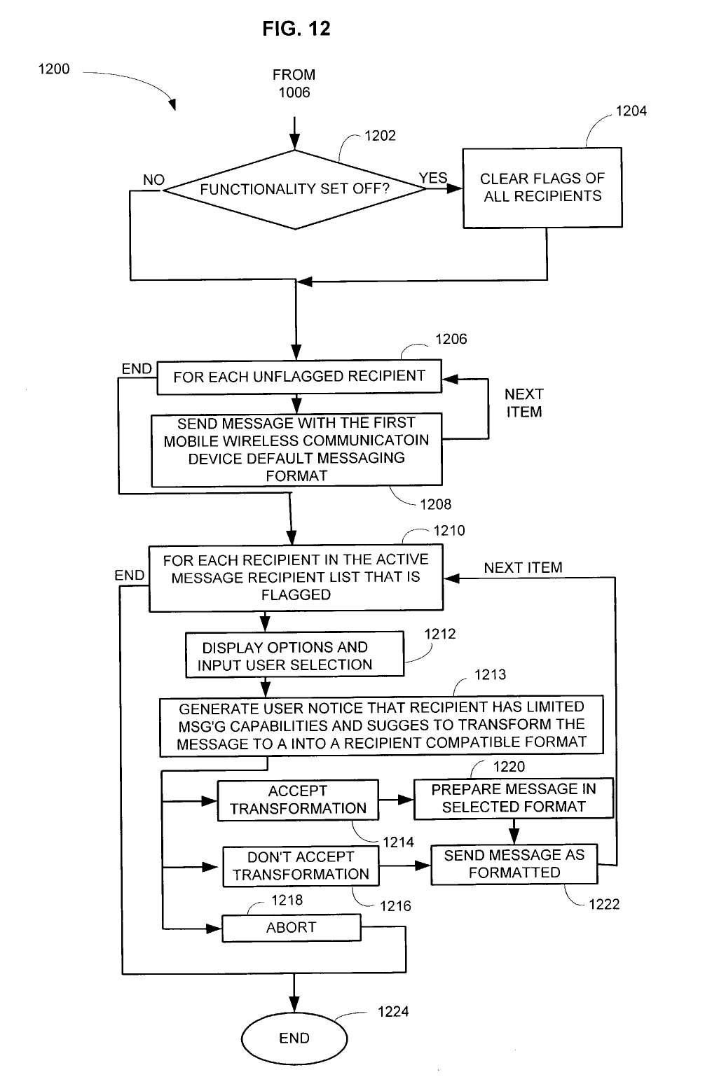

FIG. 12 further illustrates the method reflected in FIGS. 10, 11 and 12, and illustrates the sending of a message 112 after having obtained the second mobile wireless communication device messaging format capabilities information 110. More specifically, the steps of FIG. 12 are shown to follow from the steps of FIG. 10. As illustrated, the functionality represented by block 1202 is shown to follow block 1006 of FIG. 10 and demonstrates the method including performing of the function of determining whether the message capabilities determination functionality has been set off. This can be done using the send message circuitry 106 or using other suitable circuitry. Where such functionality is set off, the messaging operations are designed to send messages in a typical manner of formatting such messages in the default messaging format of the sending device. Where the functionality is set off, block 1204 shows the method includes the clearing of the flags associated with all the recipients. This functionality can be achieved using the send message circuitry 106 or other suitable circuitry. However, other embodiments achieve the function of sending messages to each of the recipients in the default format of the sending device without using flags and without clearing flags associated with each of the recipients.

Where the functionality is set on, loop block 1206 demonstrates that for each unflagged recipient, the method includes the processing through the functionality illustrated in block 1208 including the sending of messages to unflagged recipients formatted in the default messaging format of the first mobile wireless communication device 100. Here, this functionality is accomplished using the send message circuitry 106, but other suitable circuitry may be used. In this embodiment, when the functionality is found to be set off, each recipient is then sent a message in the default messaging capability of the sending device, and when the functionality is found set on, each recipient found to not have limited messaging capabilities, e.g., is able to receive a message in the default capability of the sending device, is then sent a message in the default format of the sending device. Block 1208 illustrates how the method sends a message in the default format of the sending device, the process is then returned to functionality reflected in step 1206 which processes the next item. Again, this is achieved through the send message circuitry 106 or other suitable circuitry. However, when no more unflagged/incompatible recipients remain to be processed, the functionality reflected in loop block 1206 transfers the operation to that portion of the method reflected in loop block 1210. This is achieved by using the send message circuitry 106 or other suitable circuitry.

As shown in Loop block 1210, the method includes the processing of each recipient in the active message recipient list that is flagged as not being compatible with the sending device's default messaging format. This functionality is achieved through the use of the send message circuitry 106, but may also be achieved using other suitable circuitry. FIG. 12, shows in Loop Block 1210 and block 1212, how the method displays options to the user for each flagged recipient. This also is achieved using the send message circuitry 106 or other suitable circuitry. After the options are displayed, and the user selects one of the options, the method, the performs the functionality as illustrated in one of the three corresponding blocks 1214, 1216 or 1218. This is done using the send message circuitry 106 or other suitable circuitry.

In response to the selection of option one, as shown in block 1214, the method includes the acceptance of the transformation of the message into a compatible format as found in the recipient list messaging format capabilities 406. Again, the circuitry which performs this function is the send message circuitry, but other suitable circuitry may be used. In response to the selection of the option shown in block 1216, the method does not accept the transformation of the message and ultimately the sending of the message to the second mobile wireless communication device 200 in the default messaging format of the first mobile wireless communication device 100. This is achieved using the send message circuitry 106, however, other suitable circuitry may be used. In response to the selection of option three, as shown in block 1218, the method aborts of the entire process thus preventing the sending of the message to any recipient with limited capabilities in any format. This functionality is achieved using the send message circuitry 106, but may also be achieved using other suitable circuitry.

Following each the execution of the functionality as illustrated in each of the option blocks, the functionality associated with each of the following steps are executed: the functionality shown in block 1214, where the method operates to accept of the transformation of the message into a non-default messaging format of the sending device, is followed by the functionality illustrated in block 1220 which shows the method preparing the message in the selected format. The functionality illustrated in Block 1222 illustrates that the method includes the sending of the message as currently formatted. The functionality of Block 1222 also follows the functionality illustrated in block 1216, where the decision to send the message in the default messaging format of the sending device has been chosen, and which sends the message in such a format. The functionality as illustrated in block 1224 demonstrates that after the method performs the functionality indicated in block 1218 the overall method then completes operation. Further, and where the abort selection has not been chosen, the method then performs the functionality shown in block 1210 and the method then processes a message for the next recipient. Finally, when no further recipients are left to be processed by the functionality illustrated in block 1210, the method ends as is illustrated in block 122. It should be noted that in this embodiment, the functionality associated with each of the option blocks is performed by the send message circuitry 106, however, other suitable circuitry can be used.

Further, in one embodiment, the prompting of the user is performed for groups of recipients rather than for each particular recipient. For example, a single prompt is generated for all recipients capable of receiving messages formatted in an SMS format, while all those recipients capable of receiving messages formatted in an EMS format receive their own prompt. Further, where multiple functional loops are shown in the embodiment illustrated in FIG. 12, other embodiments utilize a single loop with each of the separate functions performed in the loops as shown are performed within a single loop. In addition, other embodiments use other user prompts and options and yet other embodiments include no user prompts whatsoever. Further, although not shown in this embodiment, other embodiments include the ability to edit the message capabilities of the second mobile wireless communication device 200 as stored in a local database of the sending device.

FIG. 13 illustrates one embodiment that includes the obtaining of the second mobile wireless communication device messaging format capabilities information 110 from the second mobile wireless communication device 200. This embodiment is based on the operation of an MMS based system. Here the system includes the first mobile wireless communication device 100, a local relay/server 1302, a remote relay/server 1304 and the second mobile wireless communication device 200 communicating using multiple interfaces such as MM1 interfaces 1328 and 1332. The system further includes a series of signals used to request and retrieve the second mobile wireless communication device messaging format capabilities information 110. Such signals include: an MM1_submit.REQ 1306, an MM1_submit.RES 1308, an MM4_forward.REQ 1310, an MM4_forward.RES 1312, an MM1_notification_REQ 1314, an MM1_notification_RES 1316, an MM1_retrieve.REQ 1318, a new capabilities signal three 1320, a new capabilities signal two 1322, an MM4_delivery_report.RES 1324, and a new capabilities signal one 1326. Further, such signals are used in conjunction with the network 108. Further, found within each of the following signals: MM1_submit.REQ 1306; MM4_forward.REQ 1310 and MM1_retrieve.REQ 1318, is a second mobile wireless communication device messaging format request 226. Likewise, found within each of the following signals: new capabilities signal three 1320; new capabilities signal two 1322 and new capabilities signal one 1326, is at least the second mobile wireless communication device messaging format capabilities information 110.

In operation, the first mobile wireless communication device 100 sends an MM1_submit.REQ 1306 (including second mobile wireless communication device messaging format request 226) to the local relay/server 1302. The local relay/server 1302 sends a confirming MM1_submit.RES 1308 back to the first mobile wireless communication device 100. In addition, the local relay/server 1302 sends an MM4_forward.REQ 1310 (including second mobile wireless communication device messaging format request 226) to the remote relay/server 1304. The remote relay/server 1304 then sends a confirmation MM4_forward.RES 1312 back to the local relay/server 1302. (note that some embodiments store the second mobile wireless communication device messaging format capabilities information 110 at the remote relay/server 1304, and for such embodiments, signals 1314, 1316, 1318 and 1320 are not used). The remote relay/server 1304 also sends an MM1_notification_REQ 1314 to the second mobile wireless communication device 200. The second mobile wireless communication device 200 then sends a confirming MM1_notification_RES 1316 to the remote relay/server 1304. In response, the remote relay/server 1304 then sends an MM1_retrieve.REQ 1318 (including a second mobile wireless communication device messaging format request 226) to the second mobile wireless communication device 200. In response, the second mobile wireless communication device 200 then sends a new capabilities signal three 1320 (including the second mobile wireless communication device messaging format capabilities information 110) to the remote relay/server 1304. In response, the remote relay/server 1304 then sends a new capabilities signal two 1322 (including a second mobile wireless communication device messaging format capabilities information 110) to the local relay/server 1302 (note that some embodiments include additional formatting associated with the second mobile wireless communication device messaging format capabilities information 110 may take place when building the new capabilities signal two 1322). In response, the local relay/server 1302 sends a confirmation MM4_delivery_report.RES 1324 to the remote relay/server 1304. Finally, the local relay/server 1302 then also sends a new capabilities signal one 1326 (including a second mobile wireless communication device messaging format capabilities information 110) to the first mobile wireless communication device 100.

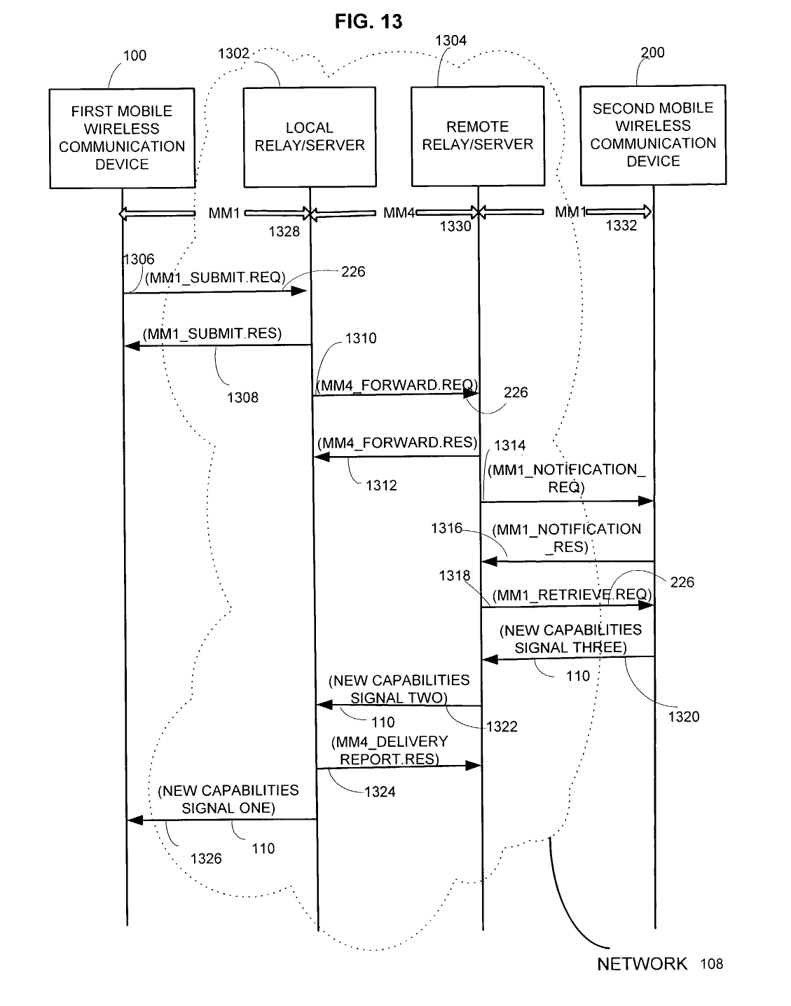

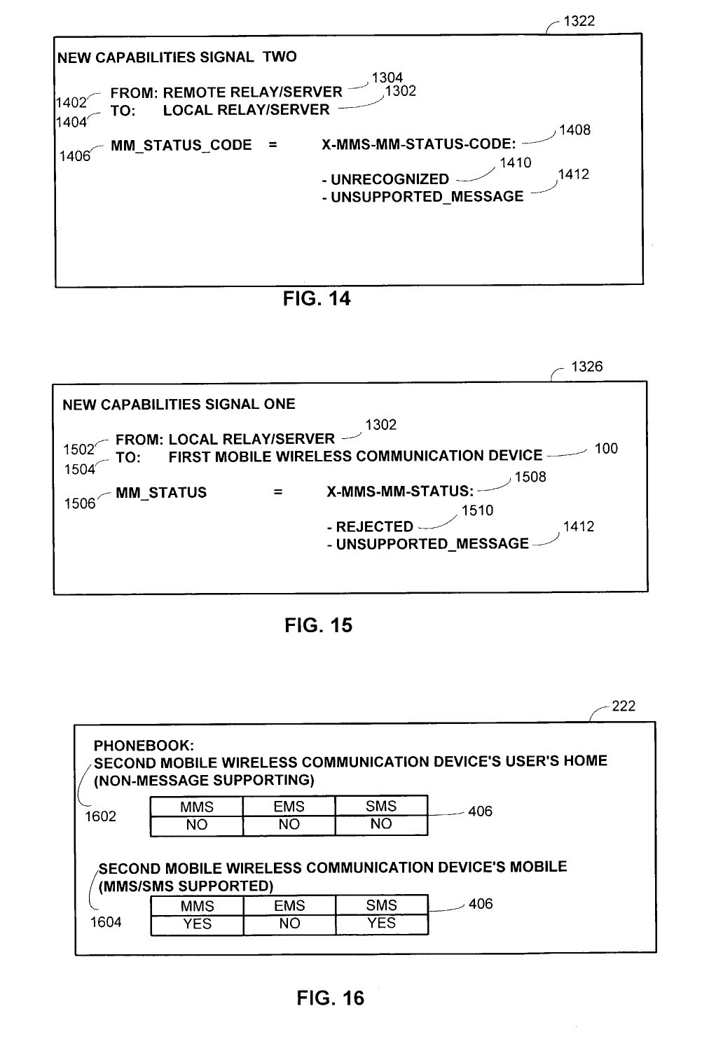

FIG. 14 illustrates, in detail, an new capabilities signal two 1322 as described in FIG. 13. More specifically, the new capabilities signal two 1322 is shown as containing a from and a to indicator, 1402 and 1404 respectively. The from indicator 1402 is shown to contain the remote relay/server 1304, while the to indicator 1404 is shown to contain the local relay/server 1302. The new capabilities signal two 1322 is also shown to contain an MM_Status_Code 1406, where the MM_Status_Code 1406 is further based on an X-MMS_Status_Code 1408, and in the case of where a message is failed to be delivered, the potential values include “unrecognized” 1410 and “unsupported message” 1412. The value “unrecognized” 1410 currently exists the MMS standard and defines the MM attachment. The value “unsupported_message” 1412 is not currently supported in the MMS standard, but will be used to indicate that the message type (e.g., x-MMS) is unsupported by the second mobile wireless communication device.

FIG. 15 illustrates, in detail, a new capabilities signal one 1326 as described in FIG. 13. More specifically, the new capabilities signal one 1322 is shown as containing a from and a to indicator, 1502 and 1504 respectively. The from indicator 1502 is shown to contain the local relay/server 1302, while the to indicator 1504 is shown to contain the first mobile wireless communication device 100. The new capabilities signal one 1326 is also shown to contain an MM_Status 1506, where the MM_Status 1506 is further based on an X-MMS_MM_Status 1508, and in the case of where a message is failed to be delivered, the potential values include “rejected” 1510 and “unsupported_message” 1412. The value “rejected” 1510 currently exists the MMS standard. As discussed above, the value “unsupported_message” 1412 is not currently supported in the MMS standard, but will be used to indicate, in this embodiment, that the message type (e.g., x-MMS) is unsupported by the second mobile wireless communication device.

FIG. 16 illustrates the storing of the recipient list messaging format capabilities 406 in the phonebook 222 as received in an new capabilities signal one 1326. Here, depending on the values received in MM_Status 1506, as returned in the new capabilities signal one 1326, the phonebook's 222 phonebook messaging format capabilities 308 are populated with the second mobile wireless communication device messaging format capabilities information 110. Specifically, in the case of a second mobile wireless communication device 200 that is a user's home phone 1602, (e.g., a communication device which does not support such messaging), each of the three listed message types will have the term “no” associated with them to indicate that each associated message type is not supported by the particular target device. However, in the case of a second mobile wireless device that is a user's mobile phone 1604, (e.g., a communication device that supports, in this case, MMS and SMS, but not EMS), each of the three listed types of messaging formats are assigned an associated value as follows: MMS=“yes”; EMS=“no”; and SMS=“yes.” As such, the values in the phonebook for the second mobile wireless communication device, which, in this case is the user's mobile phone, indicate that the second mobile wireless communication device messaging format capabilities information 110 includes both MMS and SMS messaging capabilities.

In one embodiment, while inputting the active message 216, the first mobile wireless communication device 100 will transparently contact the network talking to the address(es), (e.g., the MSISDN(s)), of the recipients(s), and try to talk with their home location register (HLR) to find out if they are capable of receiving an MMS message. No search will be done for the e-mail type of addresses for that reason (other checks may apply, e.g. is the address valid—internal in the phone). In the case that the second mobile wireless communication device(s) 100 are capable of receiving an MMS message, (e.g., where second mobile wireless communication device messaging format capabilities information 110 indicates MMS compatibility), the user and the first mobile wireless communication device 100A goes on and sends the formatted message 112. In the case that the second mobile wireless communication device(s) 100 does not support MMS messaging, the first mobile wireless communication device 100 will identify the second mobile wireless communication device 200 as having a limited messaging capabilities. In a next step, a step after a user creates an active message 216 and attempts to send it, two scenarios can occur.

In the first scenario, where there is one remote recipient (second mobile wireless communication device 200), and such remote recipient is identified as having limited messaging capabilities (e.g., where the second mobile wireless communication device messaging format capabilities information 110 does not indicate MMS compatibility), or where there are multiple remote recipients (multiple second mobile wireless communication devices 100), and each have limited messaging capabilities, then the first mobile wireless communication device 100 informs the associated user that the recipient (or recipients) have limited messaging capabilities, and suggests to the user to transform (format) the message to an SMS formatted message and send it. The first mobile wireless communication device 100 will also advice the user that any attached/inserted multimedia files will be lost. The first mobile wireless communication device 100 then prompts the user with the options to: accept, and the active message 216 is transformed or formatted into an SMS formatted message and sent; do not accept, and the unformatted message is formatted into an MMS format and sent; and abort completely; the first mobile wireless communication device 100 does not inform the user where the capability is flexed off or if flexed on, is otherwise set to the “OFF” mode. It should be noted that a message may be initially formatted in the default messaging capabilities of the sending device, (e.g., MMS format), and if necessary, may be reformatted in a new format, (e.g., SMS), before being sent.

In the second scenario where there are multiple remote recipients (multiple second mobile wireless communication devices 100), with one or more such recipients having limited messaging capabilities, (e.g., where the second mobile wireless communication device messaging format capabilities information 110 does not indicate compatibility with MMS messaging), then the first mobile wireless communication device 100 sends messages formatted in MMS to those recipient devices without limited messaging capabilities, and the first mobile wireless communication device 100 otherwise operates the same as in the first scenario described immediately above for those remaining recipients having limited capabilities.

Yet, in another embodiment, the first mobile wireless communication device 100 stores the second mobile wireless communication device messaging format capabilities information 110 corresponding to each recipient in a phonebook associated with the first mobile wireless communication device 100. This information is shown to a user of the first mobile wireless communication device 110 in the user's address book. The user has the ability to change this stored information. Here, there is also a time countdown on how often the first mobile wireless communication device 100 requests second mobile wireless communication device messaging format capabilities information 110 from the second mobile wireless communication device 200. The time is set by the operator or the manufacturer and is transparent to the user. Further, while the user is composing a test message in a default MMS format for a number of recipients, the first mobile wireless communication device 100 performs as follows: the phonebook is searched for the second mobile wireless communication device messaging format capabilities information 110, as stored in the phonebook messaging format capabilities 308. If the time has expired for any of the individual phonebook entries 312, or there are no associated phonebook messaging format capabilities 308, then the first mobile wireless communication device 100 asks the network for the second mobile wireless communication device messaging format capabilities information 110 associated with the associated recipients. The first mobile wireless communication device 100 will not wait for the responses to the requests for each of the second mobile wireless communication device messaging format capabilities information 110, the first mobile wireless communication device 100 will use all the second mobile wireless communication device messaging format capabilities information 110 it has received at the moment the user presses the “SEND” button, or after spelling and other checks are completed, right before the first mobile wireless communication device 100 attempts to send the message. The second mobile wireless communication device messaging format capabilities information 110 may arrive late, and as such, it will be absorbed by the first mobile wireless communication device 100, which will transparently update the phonebook messaging format capabilities 308 associated with the corresponding recipient.

As illustrated, the above methods and apparatus, among other things, provide for the determining of the message capabilities of a target mobile wireless communication device before sending a message to such target device. This can enhance a user's experience by allowing a user to determine whether to attempt to send or modify a message based on the messaging capabilities of the intended recipient(s) of the message. Further, the user's experience can also be enhanced by providing the user the ability to select a format in which to send a message based upon the messaging capabilities of the intended recipient(s) of the message. Yet another benefit to the user's experience includes a quick determination of the messaging capabilities of a message's intended recipient(s) by storing the message capabilities of such recipient(s) on or near the sending mobile wireless communication device. Other advantages will be recognized by those of ordinary skill in the art.

It should be understood that the implementation of other variations and modifications of the invention and its various aspects will be apparent to those of ordinary skill in the art, and that the invention is not limited by the specific embodiments described. For example, the steps described above may be carried out in any suitable order. It is therefore contemplated to cover by the present invention, and all modifications, variations, or equivalents that fall within the spirit and scope of the basic underlying principles disclosed and claimed herein.

What is claimed is:

1. A first mobile wireless communication device comprising:
mobile wireless communication device messaging format capabilities determinator circuitry operable to obtain second mobile wireless communication device messaging format capabilities information of a second mobile wireless communication device; and
send message circuitry, operable to send a message in a message format compatible with at least one of the formats identified in the second mobile wireless communication device messaging format capabilities information.

2. The device of claim 1 such that the mobile wireless communication device messaging format capabilities determinator circuitry includes remote messaging format capabilities determinator circuitry operative to:
generate a second mobile wireless communication device messaging format capabilities information request for the second mobile wireless communication device; and
receive a response containing the second mobile wireless communication device messaging format capabilities information.

3. The device of claim 1 wherein that the mobile wireless communication device messaging format capabilities determinator circuitry includes remote messaging format capabilities determinator circuitry operative to:
receive a first mobile wireless communication device messaging format capabilities information request;
retrieve first mobile wireless communication device messaging format capabilities information of the first mobile wireless communication device from the first mobile wireless communication device based on the first mobile wireless communication device messaging format capabilities information request; and
send a response to the first mobile wireless communication device messaging format capabilities information request containing the first mobile wireless communication device messaging format capabilities information.

4. The device of claim 3 wherein the mobile wireless communication device messaging format capabilities determinator circuitry includes remote messaging format capabilities determinator circuitry operative to: generate a first mobile wireless communication device messaging format capabilities list based on the first mobile wireless communication device messaging format capabilities information, for the first mobile wireless communication device from the first mobile wireless communication device based on the first mobile wireless communication device messaging format capabilities information request.

5. The device of claim 1 further comprising memory, operatively coupled to the send message circuitry, that stores the second mobile wireless communication device messaging format capabilities information of the second mobile wireless communication device.

6. The device of claim 1 further comprising memory having a phonebook that includes the second mobile wireless communication device messaging format capabilities information of the second mobile wireless communication device.

7. The device of claim 1 wherein the second mobile wireless communication device messaging format capabilities information is obtained through a transparent transfer while receiving data to be sent in the message.

8. A first mobile wireless communication device comprising:
mobile wireless communication device messaging format capabilities determinator circuitry operable to:
generate a second mobile wireless communication device messaging format capabilities information request for a second mobile wireless communication device;
receive a response to the second mobile wireless communication device messaging format capabilities information request containing second mobile wireless communication device messaging format capabilities information;
receive a first mobile wireless communication device messaging format capabilities information request from the second mobile wireless communication device;
retrieve first mobile wireless communication device messaging format capabilities information of the first mobile wireless communication device from the first mobile wireless communication device based on the first mobile wireless communication device messaging format capabilities information request; and
send a response to the first mobile wireless communication device messaging format capabilities information request containing the first mobile wireless communication device messaging format capabilities information to the second mobile wireless communication device; and
send message circuitry, operatively coupled to a network, operable to send a message to the second mobile wireless communication device in a message format compatible with at least one of the formats identified in the second mobile wireless communication device messaging format capabilities information.

9. The device of claim 8 where the send message circuitry includes a wireless transceiver to send the message in the compatible format and to receive wireless signals.

10. A wireless messaging method comprising:
obtaining mobile wireless communication device messaging format capabilities information associated with a mobile wireless communication device identifying at least one of several messaging formats that the mobile wireless communication device can process; and
sending a message in a message format compatible with at least one of the messaging formats identified in the second mobile wireless communication device messaging format capabilities information.

11. The method of claim 10 wherein obtaining mobile wireless communication device messaging format capabilities information further comprises:
generating a mobile wireless communication device messaging format capabilities information request; and
receiving a response to the request, the response containing the mobile wireless communication device messaging format capabilities information.

12. The method of claim 10 wherein obtaining mobile wireless communication device messaging format capabilities information further comprises:
receiving a first mobile wireless communication device messaging format capabilities information request;
retrieving first mobile wireless communication device messaging format capabilities information from the mobile wireless communication device based on the first mobile wireless communication device messaging format capabilities information request; and
sending a response to the first mobile wireless communication device messaging format capabilities information request containing the first mobile wireless communication device messaging format capabilities information.

13. The method of claim 12 further comprising:
generating a first mobile wireless communication device messaging format capabilities list based on the first mobile wireless communication device messaging format capabilities information, based on the first mobile wireless communication device messaging format capabilities information request.

14. The method of claim 10 further comprising storing the mobile wireless communication device messaging format capabilities information of a first mobile wireless communication device in the mobile wireless communication device.

15. The method of claim 14 further comprising storing the second mobile wireless communication device messaging format capabilities information in a phonebook in the mobile wireless communication device.

16. A wireless communication system comprising:
a first mobile wireless communication device comprising:
mobile wireless communication device messaging format capabilities determinator circuitry operable to obtain second mobile wireless communication device messaging format capabilities information of a second mobile wireless communication device; and
send message circuitry, operatively coupled to a network, operable to send a message to the second mobile wireless communication device in a message format compatible with at least one of the formats identified in the second mobile wireless communication device messaging format capabilities information; and
a second mobile wireless communication device comprising:
mobile wireless communication device messaging format capabilities determinator circuitry operable to obtain first mobile wireless communication device messaging format capabilities information of the first mobile wireless communication device; and
send message circuitry, operatively coupled to the network, operable to send a message to the first mobile wireless communication device in a message format compatible with at least one of the formats identified in the first mobile wireless communication device messaging format capabilities information.

17. The wireless communication system of claim 16 wherein the second mobile wireless communication device messaging format capabilities information is obtained through a transparent transfer while receiving data to be sent in the message to the second mobile wireless communication device.

18. The wireless communication system of claim 16 wherein the first mobile wireless communication device messaging format capabilities information is obtained through a transparent transfer while receiving data to be sent in the message to the first mobile wireless communication device.
